(19) United States
(12) Patent Application Publication
(10) Pub. No.: US 2017/0052947 A1
(43) Pub. Date: Feb. 23, 2017

(54) METHODS AND DEVICES FOR TRAINING A CLASSIFIER AND RECOGNIZING A TYPE OF INFORMATION

(71) Applicant: Xiaomi Inc., Beijing (CN)

(72) Inventors: Pingze WANG, Beijing (CN); Fei LONG, Beijing (CN); Tao ZHANG, Beijing (CN)

(73) Assignee: Xiaomi Inc., Beijing (CN)

(21) Appl. No.: 15/221,248

(22) Filed: Jul. 27, 2016

(30) Foreign Application Priority Data
Aug. 19, 2015 (CN) 201510511468.1

(51) Int. Cl. G06F 17/27; G10L 15/26

(52) U.S. Cl. CPC G06F 17/2755; G06F 17/2715; G06F 17/2775; G10L 15/26

(57) ABSTRACT

Methods and devices for training a classifier and for recognizing a type of information are provided. A method for training the classifier may include extracting, from sample information, a sample clause including a target keyword. A method may further include obtaining a sample training set by performing, on each of the sample clauses, binary labeling based on whether the respective sample clause belongs to a target class. A method may further include obtaining a plurality of words by performing word segmentation on each sample clause in the sample training set. A method may further include extracting a specified characteristic set from the plurality of words, the specified characteristic set including at least one characteristic word. A method may further include constructing a classifier based on the at least one characteristic word. A method may further include training the classifier based on results of the binary labeling of the sample clauses.

### CROSS-REFERENCE TO RELATED APPLICATION

This application claims priority to Chinese Patent Application No. 201510511468.1, filed on Aug. 19, 2015, which is incorporated herein by reference in its entirety.

### TECHNICAL FIELD

The present disclosure generally relates to the natural language processing field, and more particularly to methods and devices for training a classifier and recognizing a type of information.

### BACKGROUND

Short message content recognition and extraction is a practical application of natural language processing.

An exemplary recognition method provided in related art is birthday short message recognition. An exemplary character recognition method includes presetting a plurality of keywords; recognizing short message contents to determine whether the contents include all or part of keywords; and determining whether the short message is a message including a birth date. The use of keywords to perform type recognition in related art may not be accurate.

### SUMMARY

Because the use of keywords to perform type recognition in some related art may not be accurate, methods and devices for training a classifier and recognizing a type of information are provided in the disclosure.

According to a first aspect of the present disclosure, a method for training a classifier is provided. The method may include extracting, from sample information, a sample clause including a target keyword. The method may further include obtaining a sample training set by performing, on each of the sample clauses, binary labeling based on whether the respective sample clause belongs to a target class. The method may further include obtaining a plurality of words by performing word segmentation on each sample clause in the sample training set. The method may further include extracting a specified characteristic set from the plurality of words, the specified characteristic set including at least one characteristic word. The method may further include constructing a classifier based on the at least one characteristic word in the specified characteristic set. The method may further include training the classifier based on results of the binary labeling of the sample clauses in the sample training set.

According to a second aspect of the present disclosure, a method for recognizing a type of information is provided. The method may include extracting, from original information, clauses containing a target keyword. The method may further include generating a characteristic set of the original information based on words in the extracted clauses that match characteristic words in a specified characteristic set, wherein the characteristic words have been extracted, through word segmentation performed on sample clauses containing the target keyword, from the sample clauses containing the target keyword. The method may further include inputting the generated characteristic set of the original information into a trained classifier configured to generate a prediction result, wherein the classifier has been pre-constructed based on the characteristic words in the specified characteristic set. The method may further include obtaining a prediction result of the classifier, the prediction result representing whether the original information belongs to a target class.

According to a third aspect of the present disclosure, a device for training a classifier is provided. The device may include a processor and a memory for storing processor-executable instructions. The processor may be configured to extract, from sample information, sample clauses containing a target keyword. The processor may be further configured to obtain a sample training set by performing, on each of the sample clauses, binary labeling based on whether the respective sample clause belongs to a target class. The processor may be further configured to obtain a plurality of words by performing word segmentation on each sample clause in the sample training set. The processor may be further configured to extract a specified characteristic set from the plurality of words, wherein the specified characteristic set comprises at least one characteristic word. The processor may be further configured to construct a classifier based on the at least one characteristic word in the specified characteristic set. The processor may be further configured to train the classifier based on results of the binary labeling of the sample clauses in the sample training set.

According to a fourth aspect of the present disclosure, a device for recognizing a type of information is provided. The device may include a processor and a memory for storing processor-executable instructions. The processor may be configured to extract, from original information, clauses containing a target keyword. The processor may further configured to generate a characteristic set of the original information based on words in the extracted clauses that match characteristic words a specified characteristic set, wherein the characteristic words have been extracted, through word segmentation performed on sample clauses containing the target keyword, from the sample clauses containing the target keyword. The processor may be further configured to input the generated characteristic set of the original information into a trained classifier configured to generate a prediction result, wherein the classifier has been pre-constructed based on the characteristic words in the specified characteristic set. The processor may be further configured to obtain a prediction result of the classifier, the prediction result representing whether the original information belongs to a target class.

Both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow diagram illustrating a method for training a classifier according to an exemplary embodiment.

FIG. 2 is a flow diagram illustrating a method for training a classifier according to an exemplary embodiment.

FIG. 3 is a flow diagram illustrating a method for recognizing a type of information according to an exemplary embodiment.

FIG. 4 is a flow diagram illustrating a method for recognizing a type of information according to an exemplary embodiment.

FIG. 5 is a block diagram illustrating a device for training a classifier according to an exemplary embodiment.

FIG. 6 is a block diagram illustrating a device for training a classifier according to an exemplary embodiment.

FIG. 7 is a block diagram illustrating a device for recognizing a type of information according to an exemplary embodiment.

FIG. 8 is a block diagram illustrating a device for recognizing a type of information according to an exemplary embodiment.

FIG. 9 is a block diagram illustrating a device for training a classifier or a device for recognizing a type of information according to exemplary embodiments.

### DETAILED DESCRIPTION

Reference will now be made in detail to exemplary embodiments, examples of which are illustrated in the accompanying drawings. The following description refers to the accompanying drawings, in which the same numbers in different drawings represent the same or similar elements unless otherwise described. The implementations set forth in the following description of exemplary embodiments do not represent all implementations consistent with the disclosure. Instead, they are merely examples of devices and methods consistent with aspects related to the disclosure and the appended claims.

Due to the diversity and complexity possible in natural language expressions, it may not be accurate to directly use a target keyword to perform information type recognition. Generally, using a target keyword to recognize a text field with a targeted meaning may lead to false positives, because other words surrounding a target keyword in the text field can provide a different meaning to the text field as a whole. For example, short messages including target keywords “birthday” or “born” may be as follows:

short message 1: “Xiaomin, tomorrow is not his birthday, please do not buy a cake.”

short message 2: “Darling, is today your birthday?”

short message 3: “My son was born a year ago today.”

short message 4: “The baby who was born on May 20 has good luck.”

Of the above four short messages, only the third short message is a short message that includes a valid birth date. None of the other three short messages is a short message that includes a valid birth date.

A recognition method to categorize text fields such as instant messages, short messages (e.g. SMS messages), e-mail, etc. based on the content of the text fields could be useful in and run on a variety of devices, such as mobile phones, tablets, servers, computers, and so on. To accurately recognize the type (or class) of information in text fields such as the exemplary short message, embodiments of the disclosure provide a recognition method based on a classifier. The recognition method includes two stages: a first stage of training a classifier and a second stage of using the classifier to perform recognition of a type of information.

The following embodiments may be used to implement the above two stages.

A first stage trains a classifier:

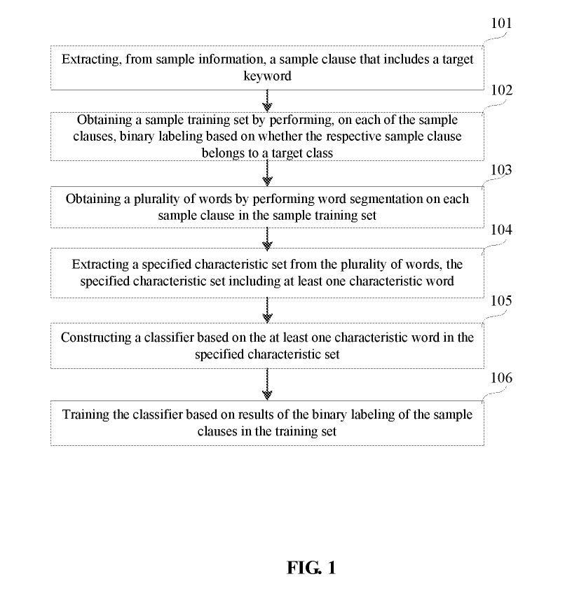

FIG. 1 is a flow diagram illustrating a method for training a classifier according to an exemplary embodiment. The method may include the following steps:

In step 101, a sample clause that includes a target keyword is extracted from sample information.

Exemplary sample information may be any of a short message, an e-mail, a microblog, or instant messaging information. Exemplary embodiments of sample information may include data packets representing the textual content of a short message, e-mail, microblog, or instant message. Sample information may be collected in advance before step 101 of the method, for example based on the sample information's word content. For example, sample information may be selected because it includes a target keyword, such as “born,” which is associated with a target meaning or context, such as that the information includes a birth date. These examples do not limit the classes of the sample information consistent with this disclosure.

Each set of sample information may include at least one clause, with a clause that includes a target keyword being a sample clause.

In step 102, a sample training set is obtained by performing, on each of the sample clauses, binary labeling based on whether the respective sample clause belongs to a target class.

In step 103, a plurality of words is obtained by performing word segmentation on each sample clause in the sample training set.

In step 104, a specified characteristic set is extracted from the plurality of words, the specified characteristic set including at least one characteristic word.

In step 105, a classifier is constructed based on the at least one characteristic word in the specified characteristic set.

An exemplary classifier constructed in step 105 is a Naive Bayes classifier.

In step 106, the classifier is trained based on results of the binary labeling of the sample clauses in the training set.

In summary, a method for training the classifier according to an embodiment of the disclosure may solve the problem in related art that merely using a keyword (such as the birthday keyword) to perform short message class analysis may lead to an inaccurate recognition result. The method may solve that problem by performing word segmentation on each sample clause in the sample training set to obtain a plurality of words, extracting a specified characteristic set from the plurality of words, and constructing a classifier based on the characteristic words in the specified characteristic set. Because the characteristic words in the specified characteristic set are extracted by performing word segmentation on sample clauses that include the target keyword, the classifier can accurately predict whether clauses include the target keyword, and thereby may achieve accurate recognition results. The method can be more accurate than methods that simply use a keyword to classify a meaning or context associated with a clause, because the method can use additional information from the clause, such as other words of the clause, to determine a meaning or context of the clause. For example, the additional information can prevent the method from falsely characterizing a message as indicating a birthdate by recognizing it includes a negating word such as “not,” which causes the clause to have an opposite meaning.

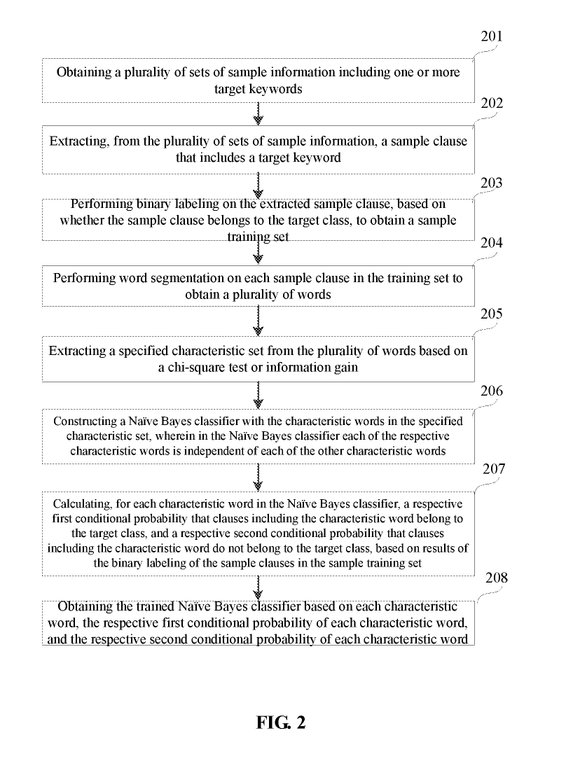

FIG. 2 is a flow diagram illustrating a method for training a classifier according to an exemplary embodiment. The method may include the following steps:

In step 201, a plurality of sets of sample information including one or more target keywords is obtained.

A target keyword is related to a target class. For example, when the target class is information that includes a valid birth date, exemplary target keywords include “birthday” and “born”. Target keywords and target classes may be predefined and stored in a server or a local terminal.

The more sets of sample information that include a target keyword which are obtained, the more accurate the constructed trained classifier may be. When the class of sample information is a short message, for example, the sets of sample information may include:

sample short message 1: “Xiaomin, tomorrow is not his birthday, please do not buy a cake.”

sample short message 2: “Darling, is today your birthday?”

sample short message 3: “My son was born a year ago today.”

sample short message 4: “The baby who was born on May 20 has good luck.”

sample short message 5: “The day on which my son was born is April Fool's Day.”

The sample short messages 1-5 are merely exemplary, and many other types of sample information will be apparent to one of skill in the art in view of this disclosure.

In step 202, a sample clause that includes a target keyword is extracted from the plurality of sets of sample information. A sample clause may be identified for extraction based upon the presence in sample information of predefined keywords or punctuation marks.

Each set of sample information may include at least one clause. A clause may be a sentence that does not include any internal dividing punctuation. For example:

sample clause 1 extracted from the sample short message 1: “tomorrow is not his birthday”

sample clause 2 extracted from the sample clause 2 extracted from the sample short message 2: “is today your birthday”

sample clause 3 extracted from the sample short message 3: “my son was born a year ago today.”

sample clause 4 extracted from the sample short message 4: “the baby who was born on May 20 has good luck”

sample clause 5 extracted from the sample short message 5: “the day on which my son was born is April Fool's Day”

In step 203, a binary labeling is performed on the extracted sample clause, based on whether the sample clause belongs to the target class, to obtain a sample training set.

Binary labeling values may be 1 and 0. When the sample clause belongs to the target class, it may be labeled with 1. When the sample clause does not belong to the target class, it may be labeled with 0.

With the above exemplary sample clauses, sample clause 1 may be labeled with 0, sample clause 2 may be labeled with 0, sample clause 3 may be labeled with 1, sample clause 4 may be labeled with 0, and sample clause 5 may be labeled with 1. In this example, the exemplary sample clauses are labeled in this manner because although all of sample clauses 1 through 5 include keywords related to birthdays, only sample clauses 3 and 5 actually disclose birthdates of a person.

The sample training set may include a plurality of sample clauses. For example, a sample training set could be obtained by dividing a sentence into a plurality of clauses by identifying the presence of predetermined dividers such as punctuation marks or the like.

In step 204, word segmentation is performed on each sample clause in the sample training set to obtain a plurality of words.

With the above exemplary sample clauses, an exemplary word segmentation may be performed on sample clause 1 to obtain five words of “tomorrow”, “is”, “not”, “his” and “birthday”; an exemplary word segmentation may be performed on sample clause 2 to obtain four words of “is”, “today”, “your” and “birthday”; an exemplary word segmentation may be performed on sample clause 3 to obtain eight words of “my”, “son”, “was”, “born”, “a”, “year ago”, and “today”; an exemplary word segmentation may be performed on sample clause 4 to obtain eleven words of “the”, “baby”, “who”, “was”, “born”, “on”, “May”, “20”, “has”, “good” and “luck”; and an exemplary word segmentation may be performed on sample clause 5 to obtain twelve words of “the”, “day”, “on”, “which”, “my”, “son”, “was”, “born”, “is”, “April”, “Fool's”, and “Day”.

That is, the resulting plurality of words may include “tomorrow”, “is”, “not”, “his”, “birthday”, “today”, “your”, “my”, “son”, “was”, “born”, “a”, “year ago”, “the”, “baby”, “who”, “on”, “May”, “20”, “has”, “good”, “luck”, “day”, “which”, “April”, “Fool's,” and so on. Obtaining the plurality of words may include generating a data packet that includes each unique word from among the sample clauses on which word segmentation was performed. In other words, obtaining the plurality of words may include analyzing the words resulting from the word segmentation of all of the sample clauses in the training set, eliminating duplicate words, and including in a data structure, as the plurality of words, the unique words.

In step 205, a specified characteristic set is extracted from the plurality of words based on a chi-square test or the information gain.

In the plurality of words obtained by performing word segmentation, some of the words may have more importance, and some words may have less importance, and therefore, not all words may be suitable for being used as a characteristic word. Extracting a specified characteristic set may include generating a data packet by extracting characteristic words from the data packet of the plurality of words that is formed in step 204, and then including those extracted words in a new data packet that is the specified characteristic set. The method may use two different ways to extract characteristic words for inclusion in the specified characteristic set.

In a first way, each of the plurality of words have their respective relevance in relation to the target class determined based on a chi-square test. Their respective relevances are ranked, and a top-ranked n number of the plurality of words are extracted from the plurality of words to form the specified characteristic set F.

The chi-square test can test the relevance of each word to the target class. The higher a relevance is, the more suitable it is used as the characteristic word corresponding to the target class.

An exemplary method for extracting a characteristic word based on the chi-square test may include the following steps:

1.1. Calculate a total number N of the sample clauses in the sample training set.

1.2. Calculate: a respective frequency A with which each word appears in the sample clauses belonging to the target class; a respective frequency B with which each word appears in the sample clauses not belonging to the target class; a respective frequency C with which each word does not appear in the sample clauses belonging to the target class; and a respective frequency D with which each word does not appear in the sample clauses not belonging to the target class.

1.3. Calculate a respective chi-square value of each word as follows:

$${χ}^{2} = \frac{{N ( AD - BC )}^{2}}{( A + C ) ( A + B ) ( B + D ) ( B + C )}$$

1.4. Rank each of words based on its respective chi-square value from large to small, and select the top-ranked n number of the plurality of words as the characteristic words of the specified characteristic set.

In a second way, each of the plurality of words have their respective information gain value determined. Their respective information gain values are ranked, and a top-ranked n number of the plurality of words are extracted from the plurality of words to form the specified characteristic set F.

Information gain refers to an amount of information a respective word provides relative to the sample training set. The greater amount of information a word provides, the more suitable the word is to be used as a characteristic word.

An exemplary method for extracting a characteristic word based on the information gain may include the following steps:

2.1. Calculate: a number N1 of the sample clauses that belong to the target class; and a number N2 of the sample clauses that do not belong to the target class.

2.2. Calculate: a respective frequency A with which each word appears in the sample clauses belonging to the target class; a respective frequency B with which each word appears in the sample clauses not belonging to the target class; a respective frequency C with which each word does not appear in the sample clause belongings to the target class; a frequency D with which each word does not appear in the sample clauses not belonging to the target class;

2.3. Calculate the information entropy as follows:

$$Entropy ( S ) = - ( \frac{N 1}{N 1 + N 2} log \frac{N 1}{N 1 + N 2} + \frac{N 2}{N 1 + N 2} log \frac{N 2}{N 1 + N 2} )$$

2.4. Calculate the information gain value of each word as follows:

$$InfoGain = Entropy ( S ) + \frac{A + B}{N 1 + N 2} ( \frac{A}{A + B} log ( \frac{A}{A + B} ) + \frac{B}{A + B} log ( \frac{B}{A + B} ) ) + \frac{C + D}{N 1 + N 2} ( \frac{C}{C + D} log ( \frac{C}{C + D} ) + \frac{D}{C + D} log ( \frac{D}{C + D} ) )$$

2.5. Rank each of words based on its respective information gain value from large to small, and select the top-ranked n number of words as the characteristic words of the specified characteristic set.

In step 206, a Naive Bayes classifier is constructed with the characteristic words in the specified characteristic set, wherein in the Naive Bayes classifier each of the respective characteristic words is independent of each of the other characteristic words.

A Naive Bayes classifier is a classifier that performs prediction based on a respective first conditional probability and a respective second conditional probability of each characteristic word. For any one characteristic word, the first conditional probability may be a probability that clauses including the characteristic word belong to the target class, and the second conditional probability may be a probability that clauses including the characteristic word do not belong to the target class.

The procedure of training the Naive Bayes classifier may include calculating the respective first conditional probability and the respective second conditional probability of each characteristic word based on the sample training set.

For example, if there are 100 sample clauses including the characteristic word “today”, of which 73 sample clauses belong to the target class, and 27 sample clauses do not belong to the target class, then the first conditional probability of the characteristic “today” is 0.73, and the second conditional probability of the characteristic “today” is 0.27.

In step 207, a respective first conditional probability that clauses including the characteristic word belong to the target class, and a respective second conditional probability that clauses including the characteristic word do not belong to the target class, are calculated for each characteristic word in the Naive Bayes classifier, based on results of the binary labeling of the sample clauses in the sample training set. For example, the total number of extracted clauses containing a respective characteristic word may be counted. The number of extracted clauses containing the respective characteristic word and that belong to the target class may be identified by counting the number of extracted clauses containing that word and that are labeled with a 1. The first conditional probability may then be calculated by dividing the first identified number by the total number. The number of extracted clauses containing the respective characteristic word and that do not belong to the target class may be identified by counting the number of extracted clauses containing that word and that are labeled with a 0. The second conditional probability may then be calculated by dividing the second identified number by the total number.

In step 208, the trained Naive Bayes classifier is obtained based on each characteristic word, the respective first conditional probability of each characteristic word, and the respective second conditional probability of each characteristic word.

In summary, a method for training the classifier according to an embodiment of the disclosure may solve the problem in related art that merely using a keyword (such as the birthday keyword) to perform short message class analysis may lead to an inaccurate recognition result. The method may solve that problem by performing word segmentation on each sample clause in the sample training set to obtain a plurality of words, extracting a specified characteristic set from the plurality of words, and constructing a classifier based on the characteristic words in the specified characteristic set. Because the characteristic words in the specified characteristic set are extracted by performing word segmentation on sample clauses that include the target keyword, the classifier can accurately predict whether clauses include the target keyword, and thereby may achieve accurate recognition results.

In an embodiment, characteristic words may be extracted from each clause of the sample training set based on the chi-square test or the information gain, and characteristic words that have a greater effect on classification accuracy may be extracted, to thereby improve the classification accuracy of the Naive Bayes classifier.

A second stage uses a classifier to perform recognition of a type of information:

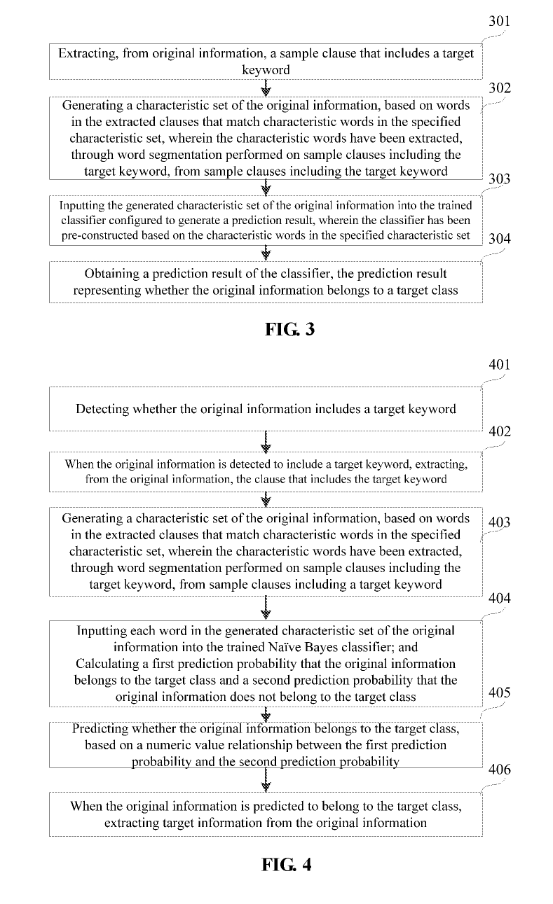

FIG. 3 is a flow diagram illustrating a method for recognizing a type of information according to an exemplary embodiment. The information type recognition method may use the trained classifier obtained in the embodiments of FIG. 1 or FIG. 2. The method may include the following steps.

In step 301, a sample clause that includes a target keyword is extracted from original information.

Exemplary original information may be any of a short message, an e-mail, a microblog, or instant messaging information. These exemplary embodiments do not limit the classes of the sample information consistent with this disclosure. Each set of original information may include at least one clause.

In step 302, a characteristic set of the original information is generated based on words in the extracted clauses that match characteristic words in the specified characteristic set, wherein the characteristic words have been extracted, through word segmentation performed on sample clauses including the target keyword, from sample clauses including the target keyword.

In step 303, the generated characteristic set of the original information is input into the trained classifier configured to generate a prediction result, wherein the classifier has been pre-constructed based on the characteristic words in the specified characteristic set.

An exemplary classifier is a Naive Bayes classifier.

In step 304, a prediction result of the classifier is obtained, the prediction result representing whether the original information belongs to a target class.

In summary, a method for recognizing a type of information according to an embodiment of the disclosure may solve the problem in related art that merely using a keyword (such as the birthday keyword) to perform short message class analysis may lead to an inaccurate recognition result. The method may solve that problem by extracting, for use as a characteristic set of the original information, the words in clauses extracted from the original information that match characteristic words in a specified characteristic set, then inputting the characteristic set of the original information into the trained classifier configured to generate a prediction result, wherein the classifier has been pre-constructed based on the characteristic words in the specified characteristic set. Because the characteristic words in the specified characteristic set are extracted by performing word segmentation on sample clauses that include the target keyword, the classifier can accurately predict whether clauses include the target keyword, and thereby may achieve accurate recognition results.

FIG. 4 is a flow diagram illustrating a method for recognizing a type of information according to an exemplary embodiment. The information type recognition method may use the trained classifier obtained in the embodiments of FIG. 1 or FIG. 2. The method may include the following steps.

In step 401, whether the original information includes a target keyword is detected.

Exemplary original information may be a short message, for example, the original information may be “my birthday is on July 28, today is not my birthday!”.

A target keyword is related to a target class. For example, when the target class is information that includes a valid birth date, the target keywords may include “birthday” and “born”.

Whether the original information includes a target keyword is detected. If yes, the procedure proceeds to step 402; otherwise, the procedure is stopped.

In step 402, when the original information includes a target keyword, the clause including the target keyword is extracted from the original information.

For example, if the original information includes a target keyword “birthday”, then the clause “my birthday is on July 28” may be extracted from the original information.

In step 403, a characteristic set of the original information is generated based words in the extracted clauses that match characteristic words in the specified characteristic set, wherein the characteristic words have been extracted, through word segmentation performed on sample clauses including the target keyword, from sample clauses including a target keyword.

For example, a specified characteristic set may be extracted according to step 205 above, and include “tomorrow”, “is”, “not”, “his”, “birthday”, “today”, “your”, “my”, “son”, “was”, “born”, “a”, “year ago”, “the”, “baby”, and so on.

The words of the clause “my birthday is on July 28” that belong to the exemplary specified characteristic set, for example by matching words in the exemplary specified characteristic set, would then include “my”, “birthday” and “is”. The three words of “my”, “birthday” and “is” are accordingly identified and used as a characteristic set of the original information.

In step 404, each word in the generated characteristic set of the original information is input into the trained Naive Bayes classifier, and a first prediction probability that the original information belongs to the target class and a second prediction probability that the original information does not belong to the target class are calculated.

The trained Naive Bayes classifier may include the respective first conditional probability and the respective second conditional probability of each characteristic word in the specified characteristic set. The respective first conditional probability is a probability that clauses including the respective characteristic word in the specified characteristic set belong to the target class, and the respective second conditional probability is a probability that clauses including the respective characteristic word in the specified characteristic set do not belong to the target class.

The first prediction probability of the original information may be equal to the product of the respective first conditional probabilities of each characteristic word in the specified characteristic set that matches a word included in the characteristic set of the original information.

For example, when the first conditional probability of “my” is 0.3, the first conditional probability of “birthday” is 0.65, and the first conditional probability of “is” is 0.7, when the original information includes those words, the first prediction probability of the original information may be calculated as being 0.3×0.65×0.7=0.11375.

The second prediction probability of the original information may be equal to the product of the respective second conditional probabilities of each characteristic word in the specified characteristic set that matches a word included in the characteristic set of original information.

For example, when the second conditional probability of “my” is 0.2, the second conditional probability of “birthday” is 0.35, the second conditional probability of “is” is 0.3, when the original information includes those words, the second prediction probability of the original information may be calculated as being 0.3×0.35×0.3=0.021.

In step 405, whether the original information belongs to the target class is predicted based on a numeric value relationship between the first prediction probability and the second prediction probability.

When the first prediction probability is larger than the second prediction probability, the prediction result may be that the original information belongs to the target class.

For example, working from the example above, 0.11375 is larger than 0.021, and therefore, the original information may be predicted to belong to the target class. In other words, in this example, it may be predicted that the original information includes a valid birth date.

When the second prediction probability is larger than the first prediction probability the prediction result may be that the original information does not belong to the target class.

In step 406, when it is predicted that the original information belongs to the target class, the target information is extracted from the original information.

Step 406 may be implemented in any of the following exemplary manners:

Generally, the birth date may be identified as being an explicit expression of the birth date in the original information, or the birth date may be identified as being a date of receiving the original information.

In one embodiment, the process may first attempt to identify the birth date as being an explicit expression of the birth date in the original information. Then, if the birth date cannot be identified using an explicit expression of the birth date in the original information, the date of receiving the original information may be identified as being the birth date.

In summary, a method for recognizing a type of information according to an embodiment of the disclosure may solve the problem in related art that merely using a keyword (such as the birthday keyword) to perform short message class analysis may lead to an inaccurate recognition result. The method may solve that problem by extracting, for use as a characteristic set of the original information, the words in clauses extracted from the original information that match characteristic words in a specified characteristic set, then inputting the characteristic set of the original information into the trained classifier configured to generate a prediction result, wherein the classifier has been pre-constructed based on the characteristic words in the specified characteristic set. Because the characteristic words in the specified characteristic set are extracted by performing word segmentation on sample clauses that include the target keyword, the classifier can accurately predict whether clauses include the target keyword, and thereby may achieve accurate recognition results.

The information type recognition method provided by an embodiment further includes: after predicting that the original information belongs to the target class, extracting the target information from the original information, and utilizing the extracted the target information, such as the birth date, the travel date, to provide data support for subsequently automatically generating reminders, calendar tag and so on.

Forgoing embodiments refer to an exemplary target class as being information that includes a valid birth date, but applications of the forgoing methods are not limited to that single exemplary target class. Other exemplary target classes may include information that includes a valid travel date, information that includes a valid holiday date, and so on, as will be apparent to one of ordinary skill in the art.

The following embodiments of the disclosure provide devices, which are configured perform methods of the disclosure. For details which are not explicitly discussed with reference to the device embodiments of the disclosure, please refer to the method embodiments of the disclosure.

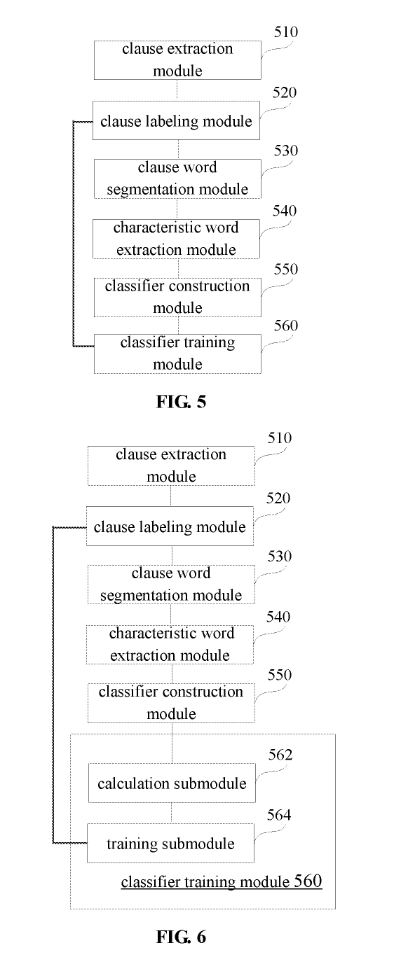

FIG. 5 is a block diagram illustrating a device for training a classifier according to an exemplary embodiment. As shown in FIG. 5, a device for training a classifier may include, but is not limited to: a clause extraction module 510 configured to extract, from sample information, sample clauses including a target keyword; a clause labeling module 520 configured to perform binary labeling on each of the extracted sample clauses, based on whether the respective sample clause belongs to a target class, to obtain a sample training set; a clause word segmentation module 530 configured to perform word segmentation on each sample clause in the sample training set to obtain a plurality of words; a characteristic word extraction module 540 configured to extract a specified characteristic set from the plurality of words, wherein the specified characteristic set includes at least one characteristic word; a classifier construction module 550 configured to construct a classifier based on the at least one characteristic word in the specified characteristic set; and a classifier training module 560 configured to train the classifier based on results of the binary labeling of the sample clauses in the sample training set.

In summary, a device for training the classifier according to an embodiment of the disclosure may solve the problem in related art that merely using a keyword (such as the birthday keyword) to perform short message class analysis may lead to an inaccurate recognition result. The device may solve that problem through modules configured to perform word segmentation on each sample clause in the sample training set to obtain a plurality of words, extract a specified characteristic set from the plurality of words, and construct a classifier based on the characteristic words in the specified characteristic set. Because the characteristic words in the specified characteristic set are extracted by performing word segmentation on sample clauses that include the target keyword, the classifier can accurately predict whether clauses include the target keyword, and thereby may achieve accurate recognition results

FIG. 6 is a block diagram illustrating a device for training a classifier according to an exemplary embodiment. As shown in FIG. 6, the device for training the classifier may include, but is not limited to: a clause extraction module 510 configured to extract, from sample information, sample clauses including a target keyword; a clause labeling module 520 configured to perform binary labeling on each of the extracted sample clauses, based on whether the respective sample clause belongs to a target class, to obtain a sample training set; a clause word segmentation module 530 configured to perform word segmentation on each sample clause in the sample training set to obtain a plurality of words; a characteristic word extraction module 540 configured to extract a specified characteristic set from the plurality of words, wherein the specified characteristic set includes at least one characteristic word; a classifier construction module 550 configured to construct a classifier based on the at least one characteristic word in the specified characteristic set; and a classifier training module 560 configured to train the classifier based on results of the binary labeling of the sample clauses in the sample training set.

Characteristic word extraction module 540 may be configured to extract the specified characteristic set from the plurality of words based on a chi-square test; or the characteristic word extraction module 540 may be configured to extract the specified characteristic set from the plurality of words based on information gain.

Classifier construction module 550 may be configured to construct a Naive Bayes classifier with the characteristic words in the specified characteristic set, wherein in the Naive Bayes classifier each of the characteristic words is independent of each of the other characteristic words.

Classifier training module 560 may include: a calculation submodule 562 configured to, for each characteristic word in the Naive Bayes classifier, calculate a respective first conditional probability that clauses including the respective characteristic word belong to the target class and a respective second conditional probability that clauses including the respective characteristic word do not belong to the target class based on results of the binary labeling of the sample clauses in the sample training set; and a training submodule 564 configured to obtain the trained Naive Bayes classifier based on each of the characteristic words, the respective first conditional probability of each characteristic word, and the respective second conditional probability of each characteristic word.

In summary, a device for training the classifier according to an embodiment of the disclosure may solve the problem in related art that merely using a keyword (such as the birthday keyword) to perform short message class analysis may lead to an inaccurate recognition result. The device may solve that problem through modules configured to perform word segmentation on each sample clause in the sample training set to obtain a plurality of words, extract a specified characteristic set from the plurality of words, and construct a classifier based on the characteristic words in the specified characteristic set. Because the characteristic words in the specified characteristic set are extracted by performing word segmentation on sample clauses that include the target keyword, the classifier can accurately predict whether clauses include the target keyword, and thereby may achieve accurate recognition results

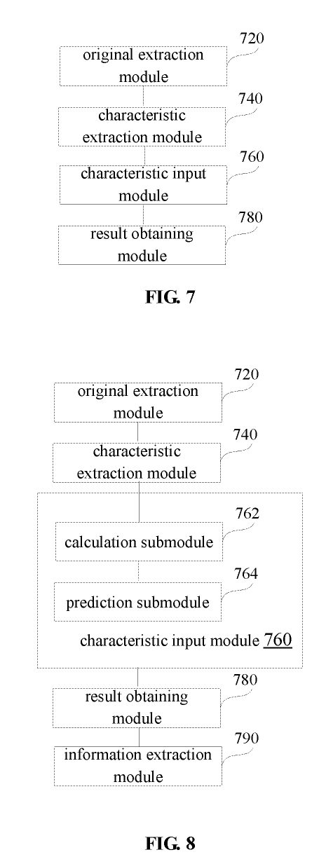

FIG. 7 is a block diagram illustrating a device for recognizing a type of information according to an exemplary embodiment. As shown in FIG. 7, a device for recognizing a type may include, but is not limited to: an original extraction module 720 configured to extract, from original information, clauses including a target keyword; a characteristic extraction module 740 configured to generate a characteristic set of the original information based on words in the extracted clauses that match characteristic words in the specified characteristic set, wherein the characteristic words have been extracted, through word segmentation performed on sample clauses including the target keyword, from the sample clauses including the target keyword; a characteristic input module 760 configured to input the generated characteristic set of the original information into the trained classifier configured to generate a prediction result, wherein the classifier has been pre-constructed based on the characteristic words in the specified characteristic set; and a result obtaining module 780 configured to obtain a prediction result of the classifier, which represents whether the original information belongs to a target class.

In summary, a device for recognizing a type of information according to an embodiment of the disclosure may solve the problem in related art that merely using a keyword (such as the birthday keyword) to perform short message class analysis may lead to an inaccurate recognition result. The device may solve that problem through modules configured to extract, for use as a characteristic set of the original information, the words in clauses extracted from the original information that match characteristic words in a specified characteristic set, then input the characteristic set of the original information into the trained classifier configured to generate a prediction result, wherein the classifier has been pre-constructed based on the characteristic words in the specified characteristic set. Because the characteristic words in the specified characteristic set are extracted by performing word segmentation on sample clauses that include the target keyword, the classifier can accurately predict whether clauses include the target keyword, and thereby may achieve accurate recognition results.

FIG. 8 is a block diagram illustrating a device for recognizing a type according to an exemplary embodiment. As shown in FIG. 8, a device for recognizing a type may include, but is not limited to: an original extraction module 720 configured to extract, from original information, clauses including a target keyword; a characteristic extraction module 740 configured to generate a characteristic set of the original information based on words in the extracted clauses that match characteristic words in the specified characteristic set, wherein the characteristic words have been extracted, through word segmentation performed on sample clauses including the target keyword, from the sample clauses including the target keyword; a characteristic input module 760 configured to input the generated characteristic set of the original information into the trained classifier configured to generate a prediction result, wherein the classifier has been pre-constructed based on the characteristic words in the specified characteristic set; and a result obtaining module 780 configured to obtain a prediction result of the classifier, which represents whether the original information belongs to a target class.

Characteristic input module 760 may include: a calculation submodule 762 configured to calculate a first prediction probability that the original information belongs to the target class and a second prediction probability that the original information does not belong to the target class, by inputting each word in the generated characteristic set of the original information into a trained Naive Bayes classifier; a prediction submodule 764 configured to predict whether the original information belongs to the target class based on a numeric value relationship between the first prediction probability and the second prediction probability; wherein the trained Naive Bayes classifier includes a first conditional probability of each characteristic word in the specified characteristic set and a respective second conditional probability of each characteristic word in the specified characteristic set, and wherein each respective first conditional probability is a probability that clauses including the respective characteristic word in the specified characteristic set belong to the target class, and each respective second conditional probability is a probability that the clauses including the respective characteristic word in the specified characteristic set do not belong to the target class.

The device may further include an information extraction module 790 configured to extract target information from the original information when the prediction result is that the original information belongs to the target class.

An exemplary form of target information is a birth date. Information extraction module 790 may be configured to identify the birth date as being an expression in the original information. Information extraction module 790 may additionally or alternatively be configured to identify the birth date as being a date of receiving the original information.

In summary, a device for recognizing a type of information according to an embodiment of the disclosure may solve the problem in related art that merely using a keyword (such as the birthday keyword) to perform short message class analysis may lead to an inaccurate recognition result. The device may solve that problem through modules configured to extract, for use as a characteristic set of the original information, the words in clauses extracted from the original information that match characteristic words in a specified characteristic set, then input the characteristic set of the original information into the trained classifier configured to generate a prediction result, wherein the classifier has been pre-constructed based on the characteristic words in the specified characteristic set. Because the characteristic words in the specified characteristic set are extracted by performing word segmentation on sample clauses that include the target keyword, the classifier can accurately predict whether clauses include the target keyword, and thereby may achieve accurate recognition results.

The information type recognition device provided by an embodiment further includes: a module configured to, when the prediction result is that the original information belongs to the target class, extract the target information from the original information, and utilize the extracted target information, such as the birth date, the travel date, etc. to provide data support for subsequently automatically generating reminders, calendar tags, and so on.

Specific details regarding how respective modules perform operations have been described in detail in embodiments related to corresponding methods, and are not described in detail here.

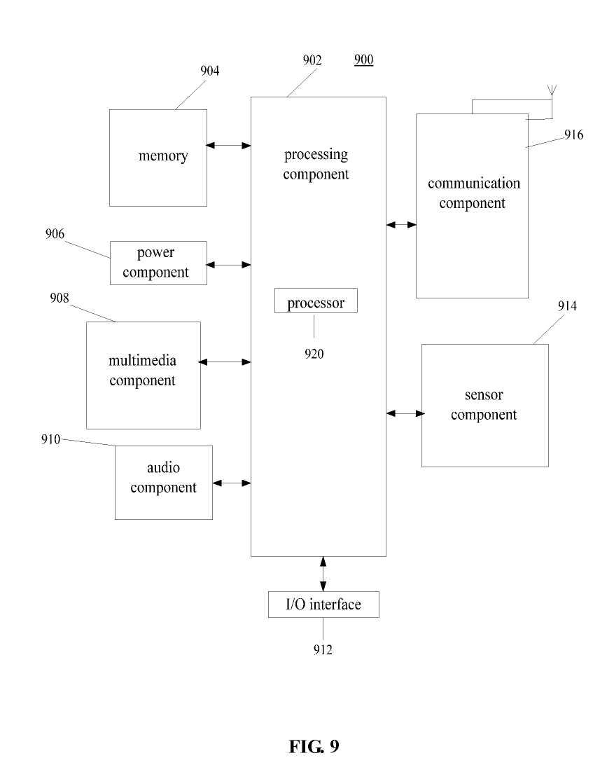

FIG. 9 is a block diagram illustrating a device for training a classifier or a device for recognizing a type of information according to an exemplary embodiment. For example, the device 900 may be a mobile phone, a computer, a digital broadcast terminal, a messaging device, a gaming console, a tablet, a medical device, exercise equipment, a personal digital assistant, and the like.

Referring to FIG. 9, the device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or more processors 918 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902. Processing component may include any or all of clause extraction module 510, clause labeling module 520, clause word segmentation module 530, characteristic word extraction module 540, classifier construction module 550, classifier training module 560, calculation submodule 562, training submodule 564, original extraction module 720, characteristic extraction module 740, characteristic input module 760, result obtaining module 780, calculation submodule 762, prediction submodule 764, result obtaining module 780, or information extraction module 790.

The memory 904 is configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power for the device 900.

The multimedia component 908 includes a screen providing an output interface between the device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 includes a front camera and/or a rear camera. The front camera and the rear camera may receive an external multimedia datum while the device 900 is in an operation mode, such as a photographing mode or a video mode. Each of the front camera and the rear camera may be a fixed optical lens system or have optical focusing and zooming capability.

The audio component 910 is configured to output and/or input audio signals. For example, the audio component 910 includes a microphone (“MIC”) configured to receive an external audio signal when the device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, the peripheral interface modules being, for example, a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900, relative positioning of components (e.g., the display and the keypad, of the device 900), a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of a nearby object without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate communication, wired or wirelessly, between the device 900 and other devices. The device 900 can access a wireless network based on a communication standard, such as WiFi, 2G, or 3G, or a combination thereof. In an exemplary embodiment, the communication component 916 receives a broadcast signal or broadcast associated information from an external broadcast management system via a broadcast channel. In an exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 904, executable by the processor 918 in the device 900, for performing the above-described methods. For example, the non-transitory computer-readable storage medium may be a ROM, a RAM, a CD-ROM, a magnetic tape, a floppy disc, an optical data storage device, and the like.

Each module discussed above, such as the clause extraction module 510, clause labeling module 520, clause word segmentation module 530, characteristic word extraction module 540, classifier construction module 550, classifier training module 560, calculation submodule 562, training submodule 564, original extraction module 720, characteristic extraction module 740, characteristic input module 760, result obtaining module 780, calculation submodule 762, prediction submodule 764, result obtaining module 780, or information extraction module 790, may take the form of a packaged functional hardware unit designed for use with other components, a portion of a program code (e.g., software or firmware) executable by the processor 918 or the processing circuitry that usually performs a particular function of related functions, or a self-contained hardware or software component that interfaces with a larger system, for example.

The methods, devices, and modules described above may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Other embodiments of the disclosure will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

It will be appreciated that the inventive concept is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for training a classifier, comprising:
extracting, from sample information, sample clauses containing a target keyword;
obtaining a sample training set by performing, on each of the sample clauses, binary labeling based on whether the respective sample clause belongs to a target class;
obtaining a plurality of words by performing word segmentation on each sample clause in the sample training set;
extracting a specified characteristic set from the plurality of words, the specified characteristic set comprising at least one characteristic word;
constructing a classifier based on the at least one characteristic word in the specified characteristic set; and
training the classifier based on results of the binary labeling of the sample clauses in the sample training set.

2. The method of claim 1, wherein extracting the specified characteristic set from the plurality of words comprises:
extracting the specified characteristic set from the plurality of words based on a chi-square test; or
extracting the specified characteristic set from the plurality of words based on information gain.

3. The method of claim 1, wherein the at least one characteristic word in the specified characteristic set comprises characteristic words, and wherein constructing the classifier based on the at least one characteristic word in the specified characteristic set comprises:
constructing a Naive Bayes classifier with the characteristic words in the specified characteristic set, wherein in the Naive Bayes classifier each of the characteristic words is independent of each other of the characteristic words.

4. The method of claim 3, wherein training the classifier based on the results of the binary labeling in the sample training set comprises:
for each of the characteristic words in the Naive Bayes classifier, calculating:
a respective first conditional probability that clauses containing a respective characteristic word belong to the target class, based on results of the binary labeling of the sample clauses in the sample training set, and
a respective second conditional probability that clauses containing the respective characteristic word do not belong to the target class, based on results of the binary labeling of the sample clauses in the sample training set; and
obtaining the trained Naive Bayes classifier based on each of the characteristic words, the respective first conditional probability of each characteristic word, and the respective second conditional probability of each characteristic word.

5. A method for recognizing a type of information, comprising:
extracting, from original information, clauses containing a target keyword;
generating a characteristic set of the original information based on words in the extracted clauses that match characteristic words in a specified characteristic set, wherein the characteristic words have been extracted, through word segmentation performed on sample clauses containing the target keyword, from the sample clauses containing the target keyword;
inputting the generated characteristic set of the original information into a trained classifier configured to generate a prediction result, wherein the classifier has been pre-constructed based on the characteristic words in the specified characteristic set; and
obtaining a prediction result of the classifier, the prediction result representing whether the original information belongs to a target class.

6. The method of claim 5, wherein inputting the generated characteristic set of the original information into the trained classifier configured to generate a prediction result comprises:
calculating a first prediction probability that the original information belongs to the target class and a second prediction probability that the original information does not belong to the target class, by inputting each word in the generated characteristic set of the original information into a trained Naive Bayes classifier; and
predicting whether the original information belongs to the target class based on a numeric value relationship between the first prediction probability and the second prediction probability;
wherein the trained Naive Bayes classifier comprises a respective first conditional probability of each characteristic word in the specified characteristic set and a respective second conditional probability of each characteristic word of each characteristic word in the specified characteristic set, and
wherein each respective first conditional probability is a probability that clauses containing the respective characteristic word in the specified characteristic set belong to the target class, and each respective second conditional probability is a probability that clauses containing the respective characteristic word in the specified characteristic set do not belong to the target class.

7. The method of claim 5, further comprising:
when the prediction result is that the original information belongs to the target class, extracting target information from the original information.

8. The method of claim 6, further comprising:
when the prediction result is that the original information belongs to the target class, extracting target information from the original information.

9. The method of claim 7, wherein the target information is a birth date, and extracting the target information from the original information comprises:
identifying the birth date as being an expression in the original information; or
identifying the birth date as being a date of receiving the original information.

10. A device for training a classifier, comprising:
a processor; and
a memory for storing processor-executable instructions,
wherein the processor is configured to:
extract, from sample information, sample clauses containing a target keyword;
obtain a sample training set by performing, on each of the sample clauses, binary labeling based on whether the respective sample clause belongs to a target class;
obtain a plurality of words by performing word segmentation on each sample clause in the sample training set;
extract a specified characteristic set from the plurality of words, wherein the specified characteristic set comprises at least one characteristic word;
construct a classifier based on the at least one characteristic word in the specified characteristic set; and
train the classifier based on results of the binary labeling of the sample clauses in the sample training set.

11. The device of claim 10, wherein the processor is further configured to:
extract the specified characteristic set from the plurality of words based on a chi-square test; or
extract the specified characteristic set from the plurality of words based on information gain.

12. The device of claim 10, wherein the processor is further configured to, when the at least one characteristic word in the specified characteristic set comprises characteristic words, construct a Naive Bayes classifier with the characteristic words in the specified characteristic set, wherein in the Naive Bayes classifier each of the characteristic words is independent of each other of the characteristic words.

13. The device of claim 12, wherein the processor is further configured to:
for each of the characteristic words in the Naïve Bayes classifier, calculate:
a respective first conditional probability that clauses containing a respective characteristic word belong to the target class, based on results of the binary labeling of the sample clauses in the sample training set, and
a respective second conditional probability that the clauses containing the respective characteristic word do not belong to the target class, based on results of the binary labeling of the sample clauses in the sample training set; and
obtain the trained Naive Bayes classifier based on each of the characteristic words, the respective first conditional probability of each characteristic word, and the second conditional probability of each characteristic word.

14. A device for recognizing a type of information, comprising:
a processor; and
a memory for storing processor-executable instructions, wherein the processor is configured to:
extract, from original information, clauses containing a target keyword;
generate a characteristic set of the original information based on words in the extracted clauses that match characteristic words a specified characteristic set, wherein the characteristic words have been extracted, through word segmentation performed on sample clauses containing the target keyword, from the sample clauses containing the target keyword;
input the generated characteristic set of the original information into a trained classifier configured to generate a prediction result, wherein the classifier has been pre-constructed based on the characteristic words in the specified characteristic set; and
obtain a prediction result of the classifier, the prediction result representing whether the original information belongs to a target class.

15. The device of claim 14, wherein the processor is further configured to:
calculate a first prediction probability that the original information belongs to the target class and a second prediction probability that the original information does not belong to the target class, by inputting each word in the generated characteristic set of the original information into a trained Naive Bayes classifier; and
predict whether the original information belongs to the target class based on a numeric value relationship between the first prediction probability and the second prediction probability;
wherein the trained Naive Bayes classifier comprises a respective first conditional probability of each characteristic word in the specified characteristic set and a respective second conditional probability of each characteristic word in the specified characteristic set, and
wherein each respective first conditional probability is a probability that clauses containing the respective characteristic word in the specified characteristic set belong to the target class, and each respective second conditional probability is a probability that the clauses containing the respective characteristic word in the specified characteristic do not belong to the target class.

16. The device of claim 14, wherein the processor is further configured to:
when the prediction result is that the original information belongs to the target class, extract target information from the original information.

17. The device of claim 15, wherein the processor is further configured to:
when the prediction result is that the original information belongs to the target class, extract target information from the original information.

18. The device of claim 16, wherein the target information is a birth date, and the processor is further configured to:
extract the birth date from the original information by identifying the birth date as being an expression in the original information; or
extract the date of receiving the original information by identifying the birth date as being a date of receiving the original information.
